(19) United States
(12) Patent Application Publication
(10) Pub. No.: US 2024/0085598 A1
(43) Pub. Date: Mar. 14, 2024

(54) NANOSTRUCTURED SURFACE COATING FOR GENERATING NOVEL VISUAL APPEARANCES

(71) Applicants: UNIVERSITE DE BORDEAUX, Bordeaux (FR); CENTRE NATIONAL DE LA RECHERCHE SCIENTIFIQUE - CNRS, Paris (FR); INSTITUT D'OPTIQUE THEORIQUE ET APPLIQUEE, Palaiseau (FR); UNIVERSITE PARIS-SACLAY, Gif Sur Yvette (FR)

(72) Inventors: Philippe LALANNE, Talence (FR); Kevin VYNCK, Bordeaux (FR); Romain PACANOWSKI, Cubzac les Ponts (FR); Xavier GRANIER, Talence (FR)

(21) Appl. No.: 18/263,620

(22) PCT Filed: Jan. 24, 2022
(86) PCT No.: PCT/FR2022/050123

§ 371 Date: Jul. 31, 2023

(30) Foreign Application Priority Data
Feb. 1, 2021 (FR) FR2100948

(51) Int. Cl. G02B 5/02

(52) U.S. Cl. CPC G02B 5/0226

(57) ABSTRACT

Nanostructured surface coating (1) configured to generate visual appearances in a visible spectrum range, comprising: —a first layer comprising a random distribution of nanoparticles (2); —a substrate (3), on which the first layer is arranged; —the nanoparticles having an optical refraction index npart having a value suitable for each individually diffusing the incident light; —the nanoparticles being arranged so that the mean distance between two adjacent particles d is defined in accordance with the following relationship so as to produce interference between the light diffused by the particles: 2 R≤d≤max (λ/nₚ), where R is the smallest geometric radius of a circle surrounding the particle, λ is the greatest wavelength of the visible spectrum, and nₚ is the optical refractive index of the medium in which the nanoparticles are dispersed.

### TECHNICAL FIELD

The present disclosure relates to the field of the interaction between light and the surface of an object. More particularly, the present disclosure relates to a nanostructured surface coating capable of controlling the interaction between light and the nanostructured surface in order to generate novel visual appearances.

### PRIOR ART

The visual appearance of an object results from the interaction between light and the material constituting the surface of the object. The visual appearances of an object are mainly classified into five categories: shape, texture, gloss, translucency and color. The first appearance categories are more geometric attributes and the last three are related to the nature of the object. For example, it is known that color arises from the selective absorption by the material and the scattering of unabsorbed light. The gloss of the surface of an object originates from the reflection of light off the outer surface of the object. The translucency results from the volume scattering and surface scattering properties of the object. Thus, it is necessary to change material, in such a way as to change the optical refractive index and/or create complex multilayer systems in order to be able to vary the spectral, angular and spatial parameters of the light reflected or transmitted by the object.

The various techniques for controlling the visual appearance use microstructures having a size that is greater than the wavelength of visible light, generally λ=500 nm, not making it possible to generate all possible visual appearances.

In multilayer systems, in order to produce controlled interferences at the interfaces between the various layers, it is necessary to perfectly control the deposition technique. Furthermore, such a multilayer system does not make it possible to generate visual effects which change arbitrarily depending on the viewing direction and the direction of the incident light.

The present disclosure proposes a nanostructured surface composed of particles having a high refractive index, of nanoscale size (of the order of around ten or a hundred nanometers) and a random but controlled spatial distribution in order to induce strong interferences between light scattered by the particles so as to generate novel appearances which exhibit colors that are resilient to the illumination and viewing directions and appearances which vary with these directions.

Surfaces comprising nanoscale components randomly spaced by a distance of the order of the wavelength of visible light are mainly used for absorption. In the present disclosure, the authors show that by controlling a certain number of parameters of such a surface, it is possible to generate novel visual appearances.

When light illuminates a surface comprising a set of randomly distributed particles, the scattering of light is governed by the size, shape, optical index, arrangement, and density of the particles dispersed in a medium that is homogeneous. The interferences between the light scattered by the scattering centers that are these particles can then play an important role in the generation of the visual appearances.

For the remainder of the disclosure, the nanostructured surface is considered to be a two-dimensional system; i.e., a layer of finite and constant thickness.

### SUMMARY

The present disclosure improves the situation.

A nanostructured surface coating configured to generate visual appearances in a visible spectral band is proposed, said coating comprising:
a first layer comprising a random distribution of nanoparticles;
a substrate on which the first layer is arranged;
nanoparticles having an optical refractive index nₚₐᵣₜ having a value suitable for each one individually to scatter the incident light;
the nanoparticles being arranged so that the average distance between two neighboring particles d is defined according to the following relationship so as to produce interference between the light scattered by the particles:

2R≤d≤max(λ/nₚ),

R: the smallest geometric radius of a circle enclosing the particle
λ: the longest wavelength of the visible spectrum
nₚ: the optical refractive index of the medium of the first layer in which the nanoparticles are dispersed.

According to one embodiment, the nanostructured surface coating further comprises a second layer arranged between the substrate and the first layer of nanoparticles:
said second layer having a thickness h less than or equal to the longest wavelength of the spectral band in the second layer:
   0≤h≤max (λ/nₛᵤₚ), nₛᵤₚ being the refractive index of the second layer.

According to one embodiment, the second layer is made of a material having a refractive index of between 1.3 and 2 and chosen from the following materials: SiO₂, sol gel, TiO₂, Si₃N₄, polymers and oxides.

According to another embodiment, the nanoparticles are arranged so that the degree of correlation p between the particles is controlled according to the following relationship:

ρπR²≤p≤0.69

p is defined by the following relationship: πμR²_{excl}, R_{excl} being the exclusion radius defining a space around the nanoparticle which excludes the presence of another nanoparticle;
R: the smallest geometric radius of a circle enclosing the particle;
ρ: surface density of a set of particles defined by the relationship 1/d², where d is the average distance between two centers of mass of the particles which are the nearest neighbors.

The features disclosed in the following paragraphs may, optionally, be implemented independently of one another or in combination with one another.

The substrate is made of a material having a refractive index of between 1.3 and 4 and chosen from the following materials: Si, AsGa, quartz, silica, polymer.

The material forming the first layer in which the nanoparticles are dispersed has a refractive index nₚ between 1 and 2, nₚ being chosen so as to be lower than the refractive index of the nanoparticles.

The nanoparticles are made of a material having a refractive index of greater than or equal to 1.4.

The nanoparticles are made of a dielectric or metallic material chosen from one of the following materials: silver, gold, aluminum, silicon, germanium, titanium dioxide, polymer, silicon nitride.

The nanoparticles have a cylindrical shape, a spherical shape, a cubic shape or any other geometric shape.

The nanoparticles have a surface fill factor f of between 5% and 30%.

### BRIEF DESCRIPTION OF THE DRAWINGS

Other features, details and advantages will become apparent on reading the detailed description below, and on analyzing the appended drawings, in which:

FIG. 1 shows a nanostructured surface coating according to a first embodiment comprising a monolayer of nanoparticles on the surface of a substrate;

FIG. 2 shows respectively (a) two diffuse reflectance spectra for spherical particles of radius R=60 nm and R=95 nm, and (b) two specular reflectance spectra for particles of radius R=60 and R=95 nm;

FIG. 3 shows a nanostructured surface coating according to a second embodiment comprising a first monolayer of nanoparticles, a substrate, and a second layer, referred to as nanoparticle support layer, arranged between the first layer of nanoparticles and the substrate;

FIG. 4 shows three backscattering efficiency curves calculated for an angle of incidence θi=30° for a coating comprising a first monolayer of silver nanoparticles of radius R=90 nm, a substrate made of Si and a second, support layer made of SiO₂ having respectively a zero thickness (h=0), a thickness h=400 nm and a thickness h=600 nm;

FIG. 5 shows angular radiation patterns calculated for an angle of incidence θi=30° and a wavelength λ=440 nm for a coating comprising a first monolayer of silver particles of radius R=90 nm, a substrate made of Si and a second, support layer made of SiO₂ having a zero thickness (h=0), a thickness h=200 nm, a thickness h=400 nm and a thickness h=600 nm;

FIG. 6 shows images of simulations showing the visual appearances of a spherical object provided with a nanostructured surface coating comprising a first monolayer of silver particles of radius R=90 nm, a substrate made of Si and a second, support layer of SiO₂ nanoparticles having a zero thickness (h=0) and a thickness h=600 nm;

FIG. 7 shows images of simulations showing the visual appearances of an object provided with a nanostructured surface coating comprising a monolayer of silver particles of radius R=90 nm, a substrate made of Si and a second, support layer made of SiO₂ having a thickness h=600 nm along three viewing directions and two incident light directions;

FIG. 8 shows a top view of a nanostructured surface coating according to a third embodiment of the invention in which the degree of correlation between the particles p is varied for the same particle density, here p=0.1 and p=0.5;

FIG. 9 shows curves of the structural correlation factor S calculated for three degrees of structural correlation p=0.5, p=0.3 and p=0.1 as a function of the wave vector q in the plane;

FIG. 10 shows images of simulations showing the visual appearances of a spherical object provided with a nanostructured surface coating comprising a monolayer of silver particles of radius r=90 nm deposited on an absorbent glass substrate for a degree of correlation p=0.1 and p=0.5;

FIG. 11 shows images of simulations showing the visual appearances of an object provided with a nanostructured surface coating comprising a monolayer of silver particles of radius R=90 nm, a substrate made of SiO₂ for a degree of correlation p=0.5 along three viewing directions and two incident light directions.

### DESCRIPTION OF THE EMBODIMENTS

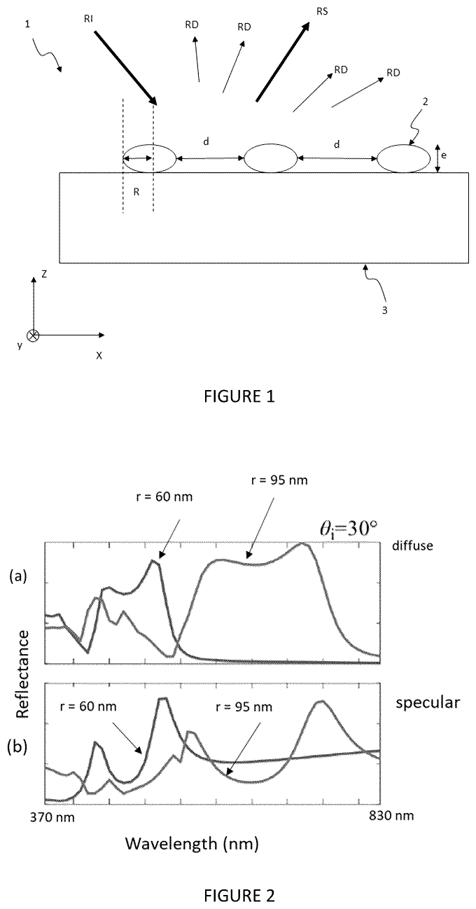

With reference to FIG. 1, a nanostructured surface coating 1 according to a first embodiment is described below. The objective of this coating is in particular to generate novel visual appearances resulting from interferences linked to diffuse light and to specular light reflected by the nanostructured surface.

The nanostructured surface coating comprises a first layer comprising a random distribution of nanoparticles 2 and a substrate 3 on which the layer of nanoparticles 2 is arranged. The substrate defines a surface in an (X,Y) plane which according to the disclosure is flat or slightly rough.

According to a first embodiment variant as illustrated in FIG. 1, the first layer of nanoparticles is formed from a set of nanoparticles distributed randomly on the surface of the substrate.

According to a second embodiment variant of the invention which is not illustrated, the particles are incorporated into a protective layer. The protective layer is made of a material with a low refractive index between 1 and 2. By way of example, the protective layer is made of SiO₂ or of plastic. The protective layer has a thickness of between a few hundred nanometers and several hundred micrometers.

The nanoparticles are randomly distributed in the (X, Y) plane. In the Z direction which is perpendicular to the (X, Y) plane, the particles have a substantially constant height and form a monolayer of particles. According to an exemplary embodiment illustrated in FIG. 1, the particles have an ellipsoidal shape and are oriented with the same height corresponding to the thickness of the monolayer. In the case of a sphere, the radius of the sphere corresponds to the thickness of the monolayer. In the case of a cylinder, the height of the cylinder corresponds to the thickness of the monolayer.

The nanoparticles have a complex optical refractive index n+ik, n being the real part corresponding to the refractive index and k the imaginary part referred to as the extinction coefficient. The nanoparticles have an optical refractive index greater than that of the protective layer. The particles have a high optical index between 1.4 and 4 in order to strongly scatter the incident light. The particles can be made of a high index metallic material, for example made of gold, silver or aluminum. They can also be made of a high index dielectric material, for example made of silicon or of titanium dioxide. They may also be made of polystyrene; they then have an index of around 1.5, capable of producing novel effects.

The particles have a geometric radius denoted R which is smaller than the wavelength of the visible spectrum. They can have different geometric shapes; spheres, cubes, rods. The geometric radius is understood to mean the radius of the smallest circle that encloses the particle. The particles can be spherical particles, cylindrical particles or cubic particles. In the case where the particle is a sphere or a cylinder, the geometric radius corresponds to the radius of the particle. The geometric radius is generally between 30 nm and 300 nm, preferably between 70 nm and 150 nm. Due to its nanoscale size, in the remainder of the description, the particles are denoted by the term “nanoparticles” and the surface of the layer comprising the nanoparticles by the term “nanostructured surface”.

Preferably, the surface fill factor is between 0.01 and 0.7, preferably between 0.01 and 0.35. The surface fill factor is understood to mean the ratio between sum of the cross sections of the particles and the total surface area of the layer.

According to the present disclosure, the applicants observe that such a nanostructured surface generates novel visual appearances when the particles are randomly distributed while satisfying the relationship according to which the average distance d between the two centers of mass of the particles which are the nearest neighbors satisfies the following relationship: 2R≤d≤max (λ/nₚ), where nₚ is the index of the protective layer in which the nanoparticles are incorporated. The distance between the particles d must be less than or equal to the effective wavelength in order to observe the visual effects. The effective wavelength is the wavelength seen by the particles incorporated in the protective layer. The wavelength therefore corresponds to the longest wavelength of the visible spectrum in the material of the protective layer. The distance between the particles d must be greater than or equal to 2R. The lower limit is imposed by the fact that the particles are considered to be impenetrable.

Due to the high optical refractive index, each particle makes it possible to localize light at a scale smaller than the visible wavelength. Due to the strong localization of the particles, they can be placed relative to one another at a distance smaller than the wavelength while forming individual scattering centers. When the nanoparticles are illuminated by an incident visible light ray IR, the ray is reflected by the particles in the form of diffuse rays DR and a specular ray SR. The interference between the beams scattered by the particles makes it possible to generate bright scattering colors which change on the object when the direction of the light which illuminates the particles changes or when the direction for viewing the particles moves, thus generating the iridescent effect.

FIG. 2 shows in graph (a) diffuse reflectance spectra and in graph (b) specular reflectance spectra calculated for two exemplary embodiments of the coating from FIG. 1. According to a first exemplary embodiment, the particles are silicon spheres having a geometric radius R=60 nm. According to a second exemplary embodiment, the particles are silicon spheres having a geometric radius R=95 nm. In the two exemplary embodiments, they are randomly distributed over the surface of a glass substrate while satisfying the criterion of the distance indicated above which must be greater than or equal to 2R. In the exemplary embodiment where the particle has a geometric radius R=60 nm, taking the index of the protective layer nₚ=1.5, and λ=740 nm as the upper limit of the visible spectrum in terms of wavelength, d must be between 120 nm and 493 nm. The surface fill factor f is equal to 10%. The light illuminates the structure with an angle of incidence of 30° and it is non-polarized.

The two diffuse reflectance spectra in graph (a) show a shift of the resonance peaks to longer wavelengths when the size of the particles increases. For the nanostructured surface coating which comprises 60 nm nanoparticles, the resonance peaks are located at around 440 nm and 520 nm. In the example with 95 nm nanoparticles, the resonance peaks are located around 600 and 750 nm. The colors related to the diffuse reflectance mainly depend on the spectrum of each of the particles.

The two specular reflectance spectra (b) show similar resonances.

According to the present disclosure, the nanostructured surface coating makes it possible to generate diffuse and specular colors that are different from one another depending on the illumination direction of the incident light and the viewing direction.

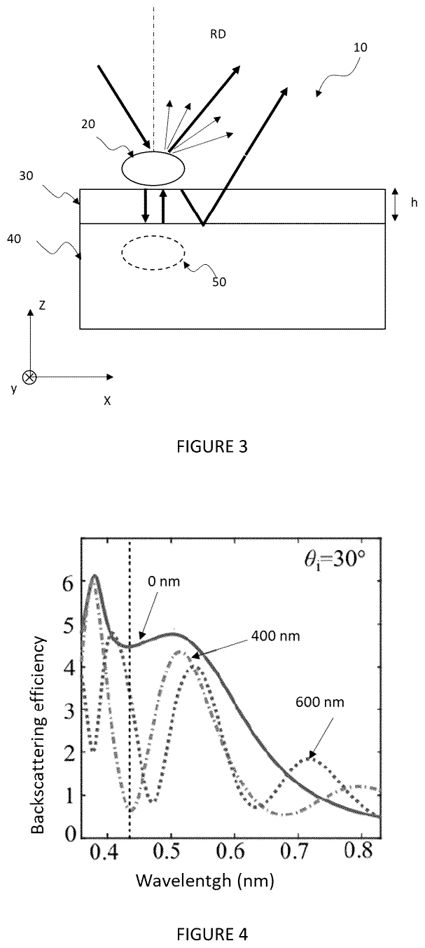

With reference to FIG. 3, a nanostructured surface coating 10 according to a second embodiment is described below.

The nanostructured surface coating comprises a first layer comprising a random distribution of nanoparticles 20, a substrate 40 and a second layer 30 arranged between the first layer 20 and the substrate 40. The substrate defines a surface in an (X, Y) plane. The second layer 30 is deposited on the substrate. The set of nanoparticles 20 is distributed randomly on the surface of the second layer 30.

According to a first variant of this second embodiment as illustrated in FIG. 3, the first layer of nanoparticles is formed solely from a set of nanoparticles distributed randomly on the surface of the second layer 30.

According to a second embodiment variant of the invention which is not illustrated, the particles are incorporated into a protective layer which extends in the (X, Y) plane. The protective layer is made of a low refractive index material. By way of example, the protective layer is made of SiO₂ or of plastic. The protective layer has a thickness of between a few hundred nanometers and several hundred micrometers. The nanoparticles are first deposited on the substrate 40. Once the monolayer of nanoparticles has been produced, a protective layer is deposited on the substrate.

The second layer 30, referred to as the nanoparticle support layer, is made of a material with a low refractive index nₛᵤₚ between 1.3 and 2. The material can be chosen from the following materials: SiO₂, TiO₂, polymer, Si₃N₄, sol gels and oxides. This second layer has a thickness of between 0 and 1 μm.

According to one embodiment of the invention, the structure of the second layer 30 is a multilayer structure.

According to an exemplary embodiment, the second layer 30 comprises a thin semi-transparent or opaque metallic layer and an SiO₂ layer, with the thin metallic layer deposited on the substrate and the layer of nanoparticles deposited on the SiO₂ layer which acts as support layer.

According to another exemplary embodiment and in the case where the substrate is a conventional glass substrate which does not reflect, the second layer 30 can be a stack of layers forming a Bragg mirror or a dielectric mirror arranged between the substrate 40 and the layer of nanoparticles 20. In this exemplary embodiment, the substrate does not need to be reflective and therefore does not need to be made of a high refractive index material.

The substrate consists of a material with a high refractive index of between 2 and 4 in order to reflect and form the virtual image 50 of the nanoparticle. The material can be a semiconductor or a metal.

As in the first embodiment, the nanoparticles are randomly distributed in the (X, Y) plane. In the Z direction which is perpendicular to the (X, Y) plane, the particles have a substantially constant thickness and form a monolayer of particles.

The presence of the substrate aims to stimulate the interaction of light with the particles forming images 50 of the particles in the substrate as indicated in FIG. 3.

The applicants observe that the modification of the thickness of the second layer supporting the particles also significantly modifies the diffuse reflectance spectrum, generating spectral maxima and minima. The applicants observe that the nanostructure generates novel visual appearances when the thickness h of the second layer 30 is less than or equal to the longest effective wavelength of the visible spectrum in the second layer 30, i.e.: 0≤h≤2 max (λ/nₛᵤₚ), nₛᵤₚ being the refractive index of the second layer 30.

FIG. 4 shows calculated backscattering efficiency curves for three exemplary embodiments of the coating illustrated in FIG. 3. In the three exemplary embodiments, the nanoparticles are silver spheres having a geometric radius R=90 nm. The substrate is made of silicon. The second layer is a layer of SiO₂. In a first exemplary embodiment, the nanoparticles are deposited directly on the substrate (h=0). The two other exemplary embodiments respectively comprise a second layer with a thickness h=400 nm and a second layer with a thickness h=600 nm. In the three exemplary embodiments, the nanoparticles are randomly distributed over the surface of the substrate or over the second layer while satisfying the criterion of the distance indicated above which must be greater than or equal to 2R. In the three embodiments, the fill factor f is 10%.

The three curves show that the light scattering spectrum varies when the thickness h varies. More specifically, the increase in the thickness h induces more significant spectral maxima and minima, resulting from the interference between the light scattered by the nanoparticles and the light reflected several times by the substrate in the second layer, at the air/layer interface and second layer/substrate interface. Air represents the medium in which the nanoparticles are dispersed at the surface of the second layer. When the nanostructured surface is illuminated, there is interference between the rays scattered by the nanoparticles and their images formed in the second layer. The thickness of the second layer h causes the distance between the images, and therefore the interferences, to vary.

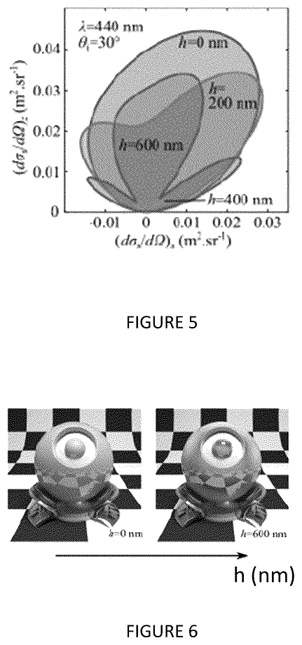

FIG. 5 shows scattering diagrams of a nanoparticle with the angle of incidence θᵢ=30° and the wavelength λ=440 nm. The angular lobes appear when the thickness h of the second layer increases, going from 0 to 600 nm.

The applicants simulated the visual appearances of coatings applied to a spherical object by varying the thickness h starting from a BRDF (bidirectional reflectance distribution function) model. They observed that when the thickness h of the second layer increases, bright diffuse colors appear starting from a pale bluish gray due to the changes in the scattering spectra and scattering patterns shown in FIGS. 4 and 5.

FIG. 6 shows images of a simulated visual appearance for two spheres respectively provided with a coating without the presence of the second layer and with a second layer of thickness h=600 nm. On the sphere without the presence of the second layer, the color due to the silver nanoparticles is pale bluish gray. On the sphere with a second layer of 600 nm, areas of bright colors appear which are represented by dark areas. The nanoparticles are dispersed randomly with a fill factor f=10%, corresponding to a surface density ρ=4 μm⁻¹. The applicants observe that the areas of bright colors, represented by darker areas, appear as the thickness h of the film increases.

The applicants also observe that the visual appearance of a non-spherical object coated with a second layer of non-zero thickness varies with the direction of incident light and with the viewing direction, thus giving a “diffuse iridescence” effect.

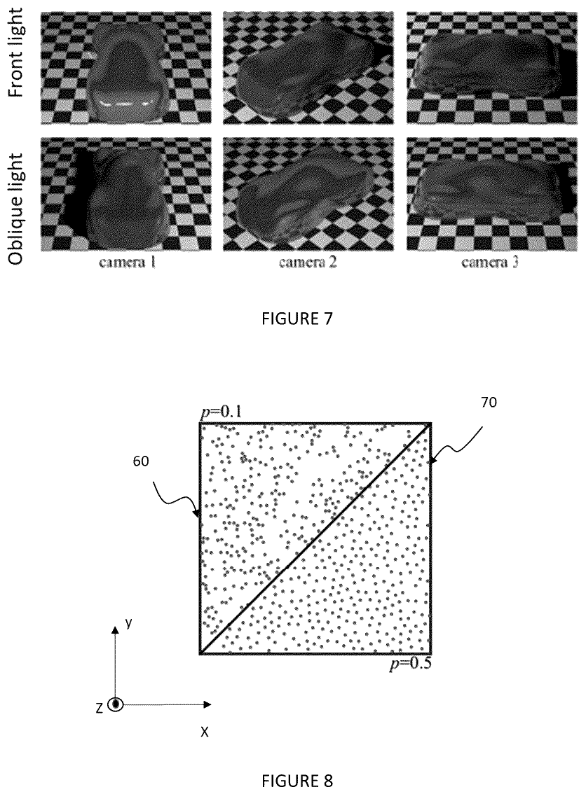

FIG. 7 shows simulations of visual appearance for a coating with a second layer of thickness h=600 nm according to three viewing positions which are represented by three virtual cameras and for two different illumination positions. The applicants observe that two diffuse colors, green and purple, are generated. The first appears for small angles of incidence and the second for large angles of incidence. The presence of randomly dispersed nanoparticles on the surface of the second layer combined with a finite thickness of the second layer makes it possible to obtain two different colors on the same object. Such a visual effect cannot be generated with the solutions of the prior art which are based mainly on multilayer structures which only produce interferences linked to the interfaces.

With reference to FIG. 8, a coating according to a third embodiment of the invention is described below.

As in the case of the first embodiment, the nanostructured surface coating comprises a first layer comprising a random distribution of nanoparticles and a substrate, the first layer being arranged on the substrate.

In a first variant, the first layer is formed solely of nanoparticles without the protective layer.

In a second variant, the first layer is formed of nanoparticles incorporated in a protective layer.

The applicants observe that structural correlations between the nanoparticles have an impact on the visual appearance. More specifically, the applicants show that it is possible to generate novel appearances by controlling structural correlations, i.e. by forcing particles to remain at a minimum distance d_{excl} from one another according to the relationship d_{excl}=2R_{excl} from center to center, R_{excl} being a radius of exclusion that defines a space around the nanoparticle that excludes the presence of other nanoparticles. The control of the correlation results via the control of the degree of correlation p which is defined from the radius of exclusion R_{excl} of the particle according to the following relationship: p=ρπR_{excl}², where ρ is the surface density of a set of particles substantially equal to 1/d_{excl}².

The applicants observe that the nanostructure generates novel visual appearances when the degree of correlation p satisfies the following relationship: πμR_{excl}²≤p≤0.69. The upper limit 0.69 is the limit beyond which the nanoparticles are no longer considered to be a random system since they form periodic small clusters. When p is close to 0.90, the system can be considered to be a periodic system. In the exemplary embodiment where the particle has a geometric radius R=60 nm and d_{excl}=300 nm, a density ρ=12.8 μm⁻¹ is obtained and the degree of structural correlation p must be between 0.145 and 0.69 in order to be able to control the structural correlation so as to generate novel visual appearances.

FIG. 8 illustrates a top view of a surface comprising dispersed nanoparticles with a degree of correlation p=0.1 and a surface comprising nanoparticles with a degree of correlation p=0.5 for an identical surface density ρ.

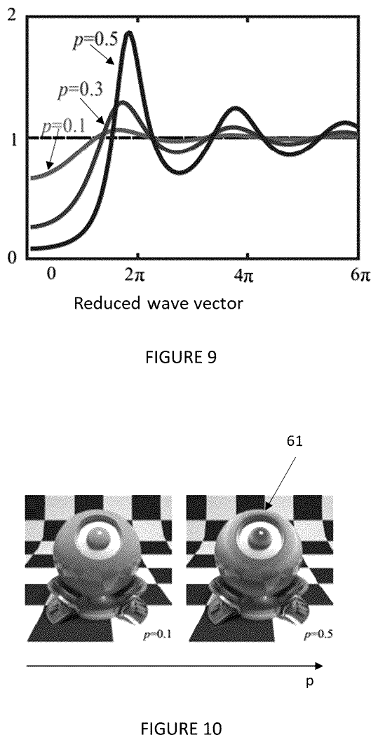

FIG. 9 shows the structural factor S calculated for various degrees of correlation as a function of the scattering wave vector in the q∥. plane. The curves show that the structural correlation S can suppress or increase scattering. By increasing the degree of correlation, the S factor is substantially zero around the specular direction (q∥=0) and increases at greater wave vectors.

FIG. 10 shows the simulated visual appearances of two spheres covered with a nanostructured surface coating for different degrees of correlation. The coating comprises silver nanoparticles deposited on a glass substrate with a fill factor f=0.1. By increasing the degree of correlation, it is possible to generate novel visual effects, and in particular to make appear in the area 61 covered with nanoparticles around the specular direction a color gradient different from that encountered in the rainbow.

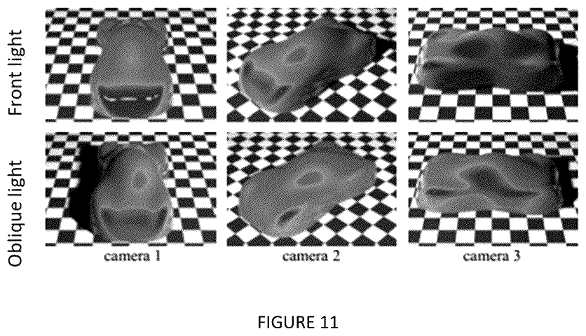

FIG. 11 shows simulations of visual appearance for a coating with a degree of correlation p=0.5 according to three viewing positions which are represented by three virtual cameras and for two different illumination positions. Unlike the diffuse iridescence effect obtained in the exemplary embodiment illustrated in FIG. 7, the colors generated always follow the specular direction. The dark regions always appear when the viewing angle and the specular direction are coincident.

### INDUSTRIAL APPLICATION

The nanostructured surface coating of the present invention makes it possible to generate novel visual appearances by controlling the thickness h of the layer supporting the particles, the distance between two particles d and the degree of structural correlation p on the scale of the wavelength of the visible spectrum. Such a nanostructured surface coating can be used in various industrial fields in which the visual appearance is essential in order to make the object more esthetic while overcoming technical constraints, such as the motor vehicle industry, the cosmetics field, the packaging industry, and printing.

1. A nanostructured surface coating configured to generate visual appearances in a visible spectral band, comprising:
a first layer comprising a random distribution of nanoparticles; and
a substrate on which the first layer is arranged;
wherein the nanoparticles each have an optical refractive index nₚₐᵣₜ value suitable for each one individually to scatter incident light;
wherein the nanoparticles are arranged so that the average distance d between two neighboring nanoparticles of the nanoparticles is defined according to the following relationship so as to produce an interference between the light scattered by the two neighboring nanoparticles:
2R≤d≤max(λ/nₚ),
R: a smallest geometric radius of a circle enclosing the two neighboring nano particles
λ: a longest wavelength of a visible spectrum
nₚ: an optical refractive index of a medium of the first layer in which the nanoparticles are randomly distributed.

2. The nanostructured surface coating as claimed in claim 1, further comprising a second layer arranged between the substrate and the first layer of nanoparticles
wherein said second layer has a thickness h less than or equal to a longest wavelength of a spectral band in the second layer:
0≤h≤max(λ/nₛᵤₚ),
nₛᵤₚ being the refractive index of the second layer.

3. The nanostructured surface coating as claimed in claim 2, wherein the second layer is comprised of a material having a refractive index of between 1.3 and 2 and wherein the material is selected from the group consisting of SiO₂, sol gel, TiO₂, Si₃N₄, polymers, and oxides.

4. The nanostructured surface coating as claimed in claim 1, wherein the substrate is comprised of a material having a refractive index of between 1.3 and 4 and wherein the material is selected from the group consisting of Si, AsGa, quartz, silica, and polymers.

5. The nanostructured surface coating as claimed in claim 1, wherein the material forming the first layer in which the nanoparticles are dispersed has a refractive index nₚ between 1 and 2, nₚ being chosen so as to be lower than the refractive index of the nanoparticles.

6. The nanostructured surface coating as claimed in claim 1, wherein the nanoparticles are arranged so that a degree of correlation p between the nanoparticles is controlled according to the following relationship:
ρπR²≤p≤0.69
p is defined by the following relationship: ρπR²_{excl}, R_{excl} being the exclusion radius defining a space around a nanoparticle which excludes the presence of another nanoparticle;
R is as previously defined; and
ρ is a surface density of a set of particles defined by a relationship 1/d², where d is an average distance between two centers of mass of the two neighboring nanoparticles.

7. The nanostructured surface coating as claimed in claim 1, wherein the nanoparticles are made of a material having a refractive index of greater than or equal to 1.4.

8. The nanostructured surface coating as claimed in claim 1, wherein the nanoparticles are made of a dielectric or metallic material selected from the group consisting of silver, gold, aluminum, silicon, germanium, titanium dioxide, polymer, and silicon nitride.

9. The nanostructured surface coating as claimed in claim 1, wherein the nanoparticles have a cylindrical shape, a spherical shape, a cubic shape or any other geometric shape.

10. The nanostructured surface coating as claimed in claim 1, wherein the nanoparticles have a surface fill factor f of between 5% and 30%.
